(19) United States
(12) Patent Application Publication
(10) Pub. No.: US 2011/0017482 A1
(43) Pub. Date: Jan. 27, 2011

(54) Roller Technology

(76) Inventors: Carl A. Keith, Bruce, WI (US); Scott B. Taylor, Exeland, WI (US)

Correspondence Address: JOEL D. SKINNER, JR.;SKINNER AND ASSOCIATES, 212 COMMERCIAL ST., HUDSON, WI, 54016, US

(21) Appl. No.: 12/804,552

(22) Filed: Jul. 23, 2010

Related U.S. Application Data
(60) Provisional application No. 61/227,933, filed on Jul. 23, 2009.

(51) Int. Cl. A01B 45/00

(52) U.S. Cl. 172/75; 172/108; 172/431

(57) ABSTRACT

A roller that is particularly useful for use with golf course greens. The roller has a base having front, rear and opposing sides, the base having a frame and a deck disposed on the frame. An operator seat is disposed on a base deck and fixedly oriented toward the front of the roller. Operator controls are disposed in front of the seat. The roller has a driven roller which normally rolls substantially in the front and rear directions. The driven roller is cylindrical and rotates about an elongated axis which is oriented substantially normally side to side with respect to the roller. The driven roller is disposed behind the seat.

### CROSS-REFERENCE TO RELATED APPLICATIONS, IF ANY

This application claims the benefit under 35 U.S.C. §119(e) of co-pending U.S. Provisional Patent Application Ser. No. 61/227,933, filed Jul. 23, 2009, which is hereby incorporated by reference.

### 37 C.F.R. §1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to golf course maintenance, sports turf, and professional turf care systems, apparatus and methods. Particularly, the invention relates to a turf roller therefor.

2. Background Information

Greens rollers are typically used to flatten a golf course green to make it more smoother, more consistent and faster (with respect to a rolling golf ball). Known greens rollers are side facing and drive side to side.

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides a turf roller apparatus and method which are practical, reliable, accurate and efficient, and which is believed to fulfill the need and to constitute an improvement over the background technology.

The forward facing greens roller of the present invention is believed to provide better visibility to the operator, better control and to be easier to operate.

In one aspect, the invention provides a roller comprising a base having front, rear and opposing sides, an operator seat connected to the base and oriented toward the front of the roller, and at least one driven roller which normally rolls substantially in the front and rear directions.

In another aspect, the invention provides a golf course greens roller, comprising

a. a base having front, rear and opposing sides, the base having a frame and at least one deck disposed on the frame;

b. an operator seat disposed on at least one base deck and fixedly oriented toward the front of the roller;

c. operator controls disposed in front of the seat; and

d. a driven roller which normally rolls substantially in the front and rear directions, the driven roller being cylindrical and rotating about an elongated axis, the elongated axis being oriented substantially normally side to side with respect to the roller the driven roller being disposed behind the seat.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a perspective view of an embodiment of the roller of the invention.

FIG. 2 is a side elevation view of the roller.

FIG. 3 is an opposite side view of the roller.

FIG. 4 is a front, end view of the roller.

FIG. 5 is a back end view of the roller.

FIG. 6 is a top, plan view of the roller.

FIG. 7 is a perspective view an embodiment of a drive roller of the roller apparatus.

FIG. 8 is a perspective view of an embodiment of a spike roller of the roller apparatus.

FIG. 9 is a perspective view of an embodiment of a power plant of the roller apparatus.

FIG. 10 shows an embodiment of an embodiment of a nose cone and control panel of the roller apparatus.

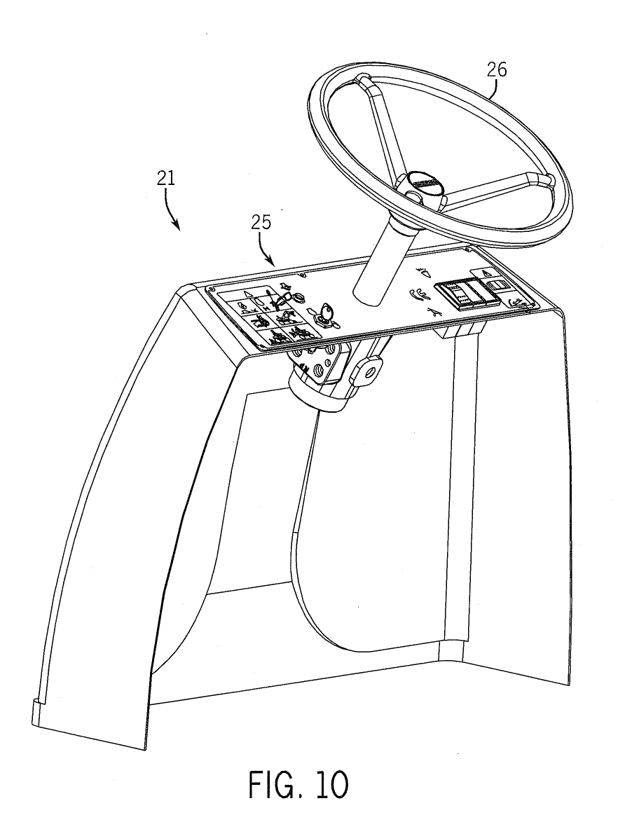

FIG. 11 is a schematic diagram of an embodiment of the electrical circuitry of the roller apparatus.

FIG. 12 is a perspective view of an embodiment of the main frame of the roller.

FIG. 13 is a perspective view of an embodiment of the drive roller frame of the roller.

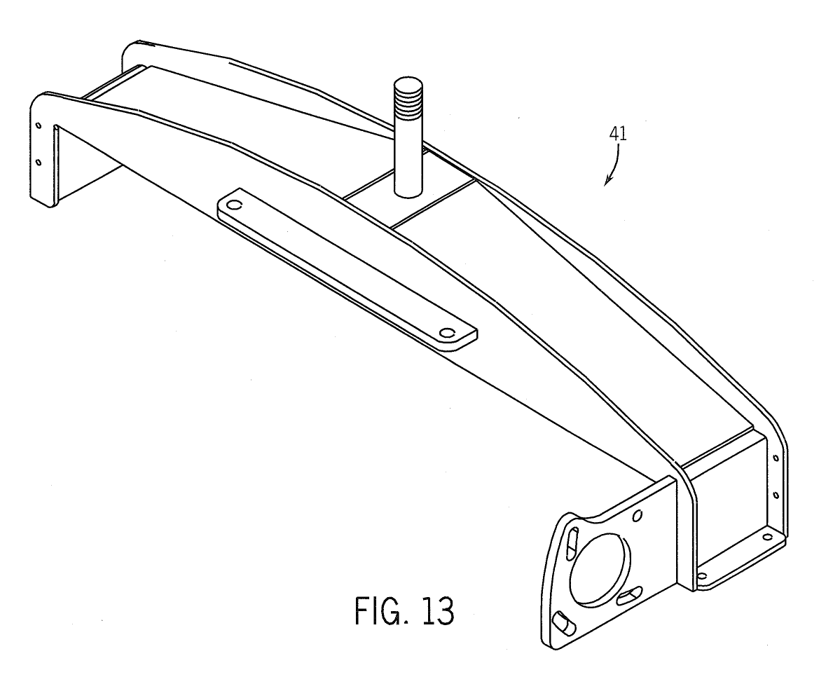

FIG. 14 is a perspective view of an embodiment of the front roller frame of the roller.

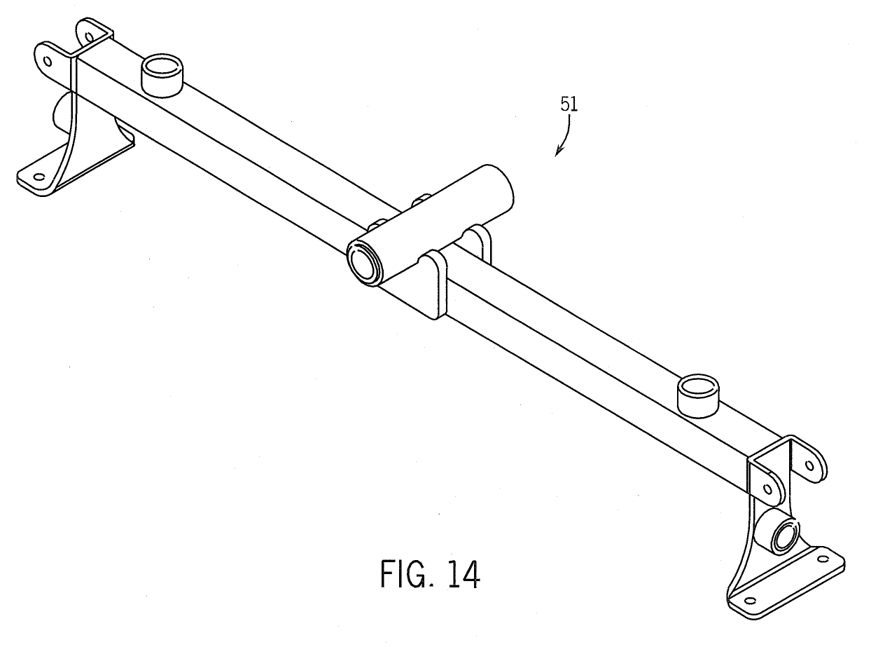

FIG. 15 is a perspective view of an embodiment of the spiker frame of the roller.

### DETAILED DESCRIPTION

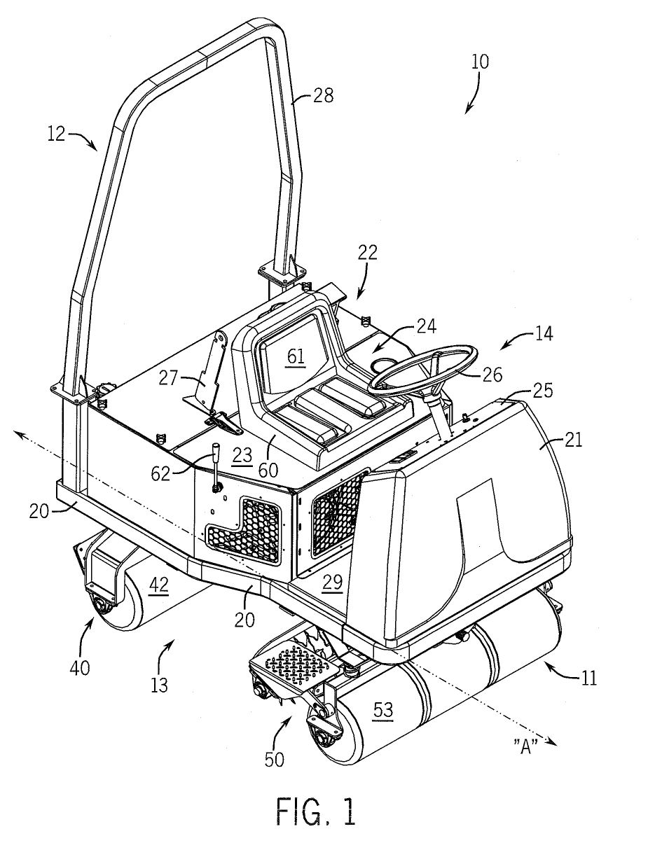

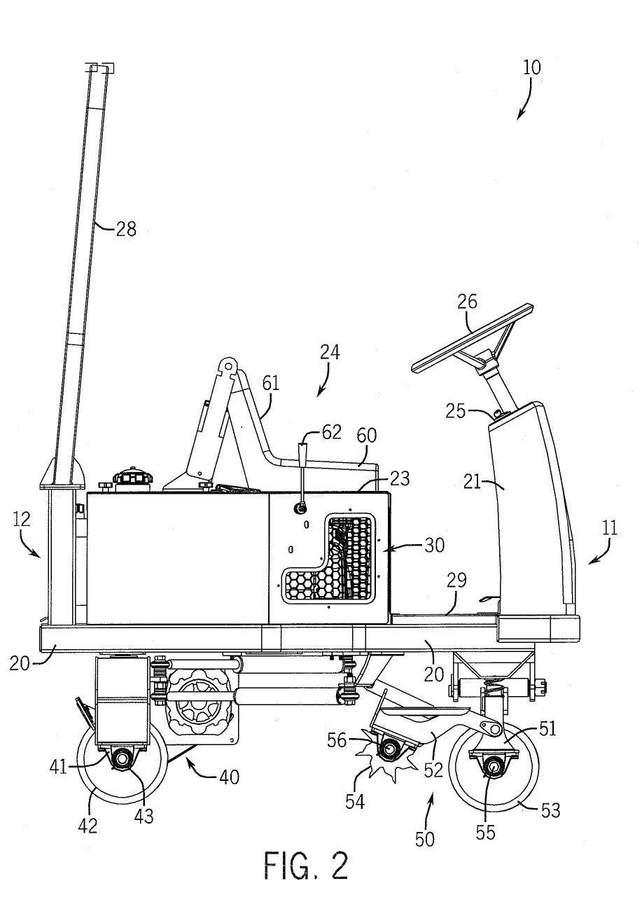

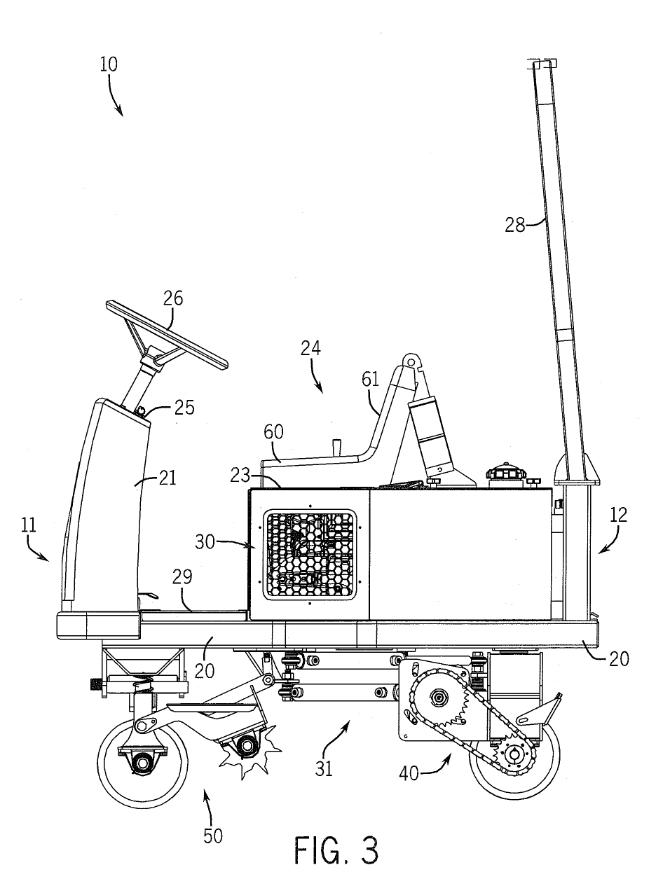

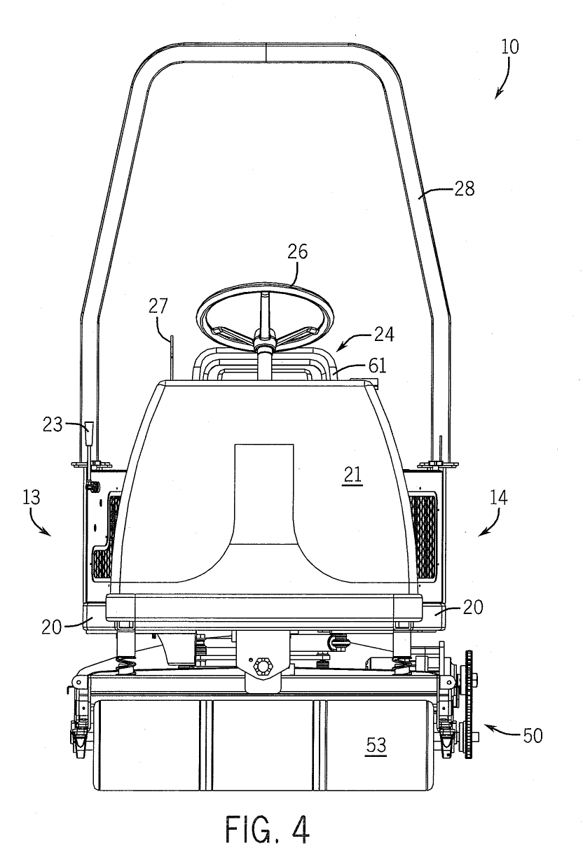

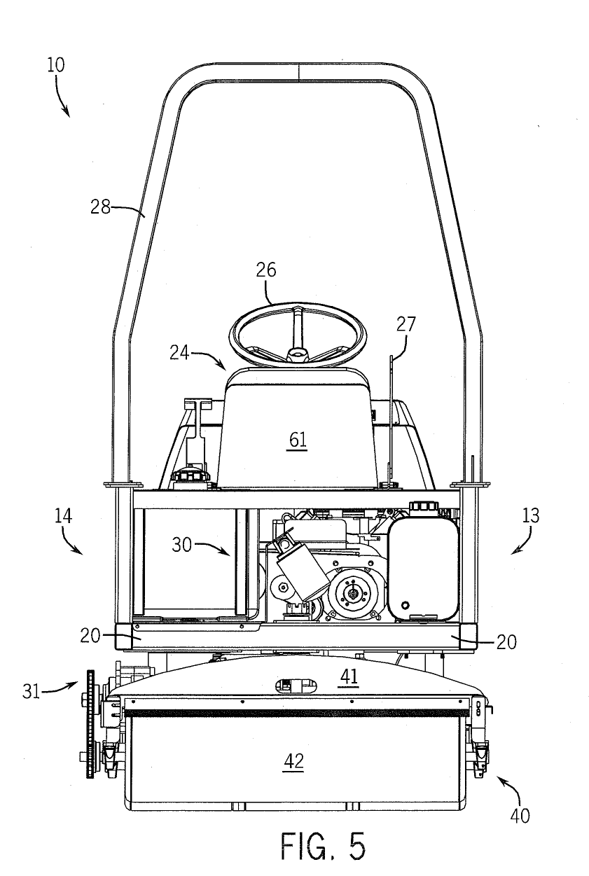

FIGS. 1-6, show an embodiment of the roller 10 of the present invention. The roller is especially suited for rolling greens on golf courses.

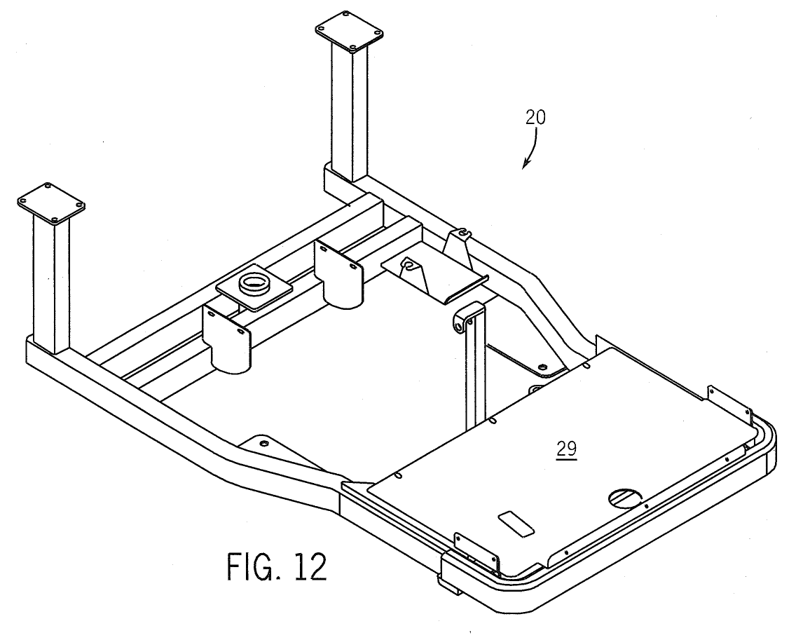

The roller 10 has a front end 11, a rear end 12 and right and left sides 13 and 14 respectively. Referring also to FIG. 12, the roller 10 has a main frame 20 with a forward deck area 29. A nose cone 21 is disposed at the forward end of the frame 20. The nose cone 21 has a control console 25 and a steering wheel 24. The deck area 25 is disposed behind the nose cone 21. The operator seating assembly 22 is disposed behind the deck area 25. The assembly 22 has a flat seat deck 23 upon which is disposed a seat 24. The seat has a horizontal base member 60 and an upright, substantially vertical seat back member 61. Seat belt anchors 27 and a control stick are disposed near the seat 24. A Roll Over Protection System (ROPS) bar 28 is disposed behind and over the operator seat 25. Significantly, the seat 24, foot deck 25 and steering wheel 26 are all oriented and fixed facing in the forward direction 11 of the roller 10.

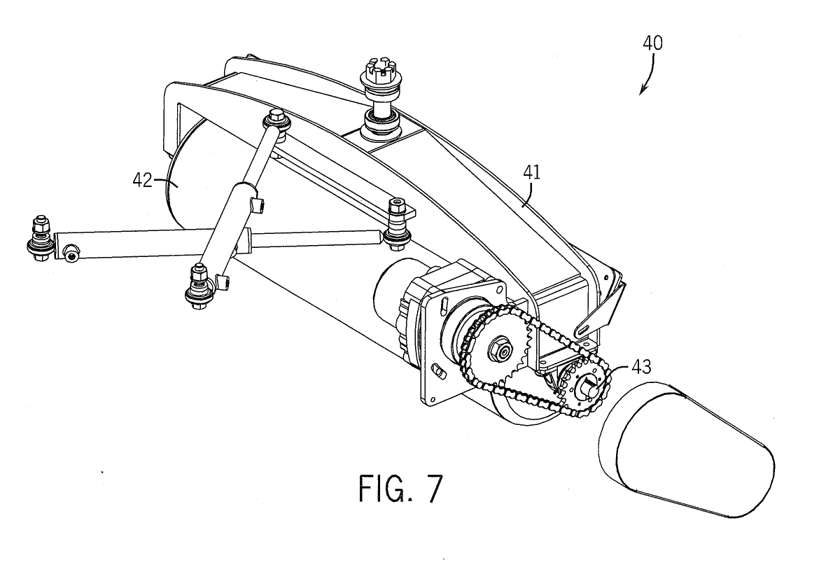

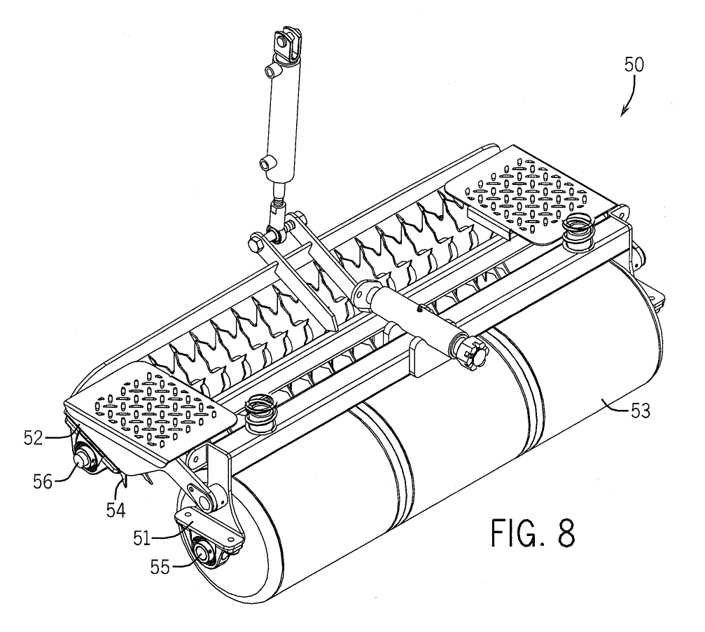

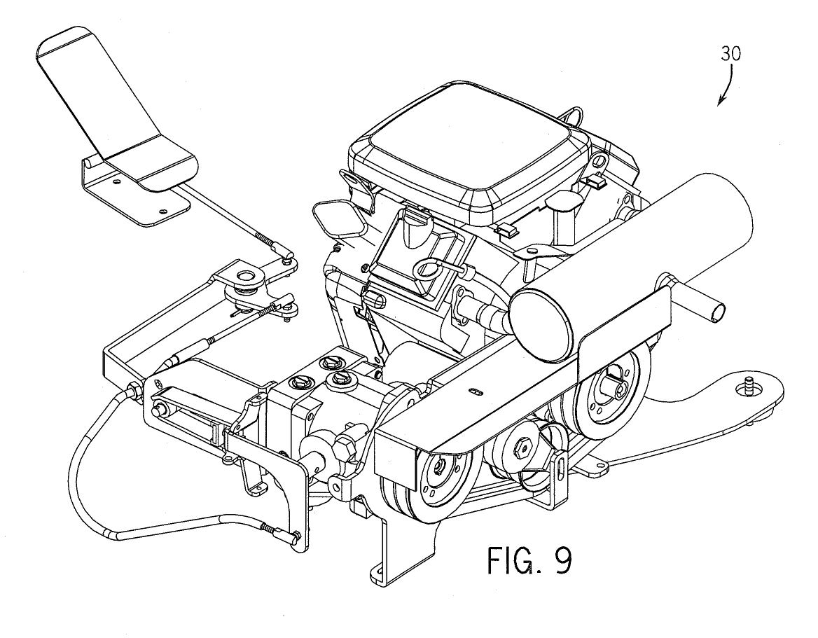

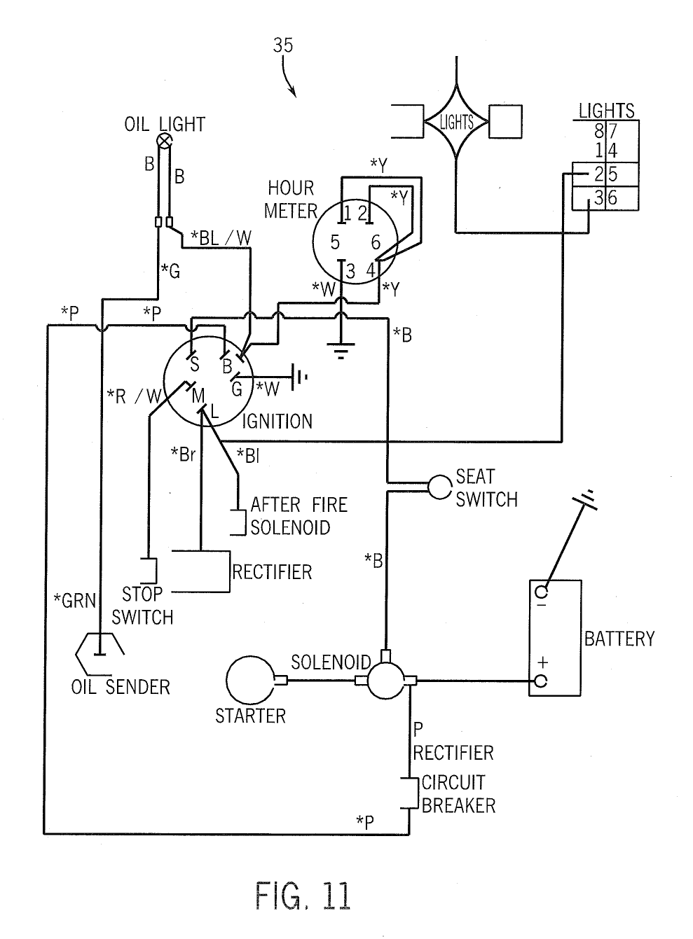

Referring also to FIG. 9, the roller 10 also comprises a power plant 30 and drive train 31 communicatively connected to a roller system including a rear drive roller assembly 40 (shown also in FIG. 7) and a front roller/spiker assembly 50 (shown also in FIG. 8). The power plant is housed below the seat deck 23. Referring also to FIG. 11, an electrical system 35 is communicatively connected to the console 25 and power plant 30.

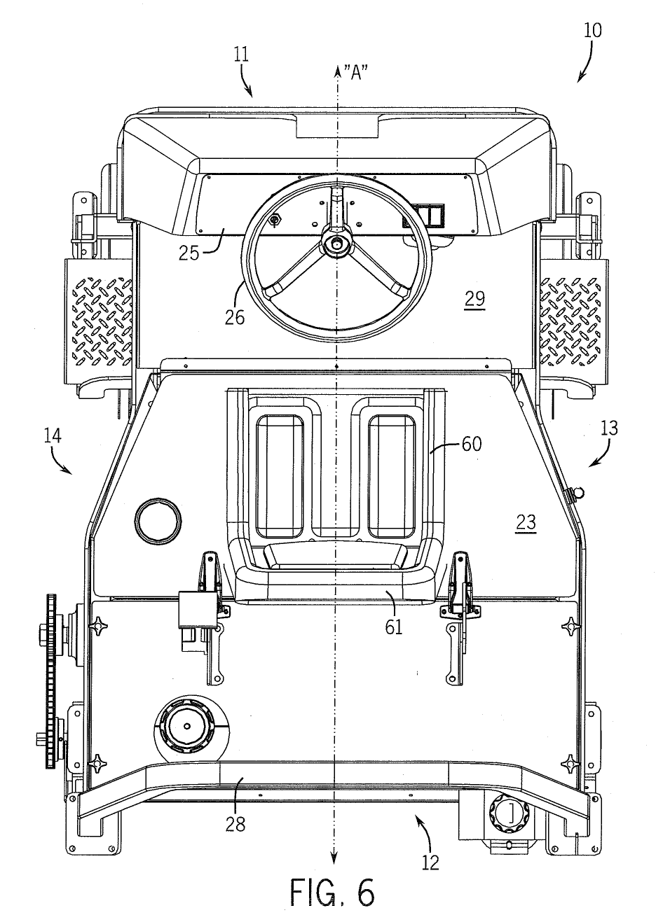

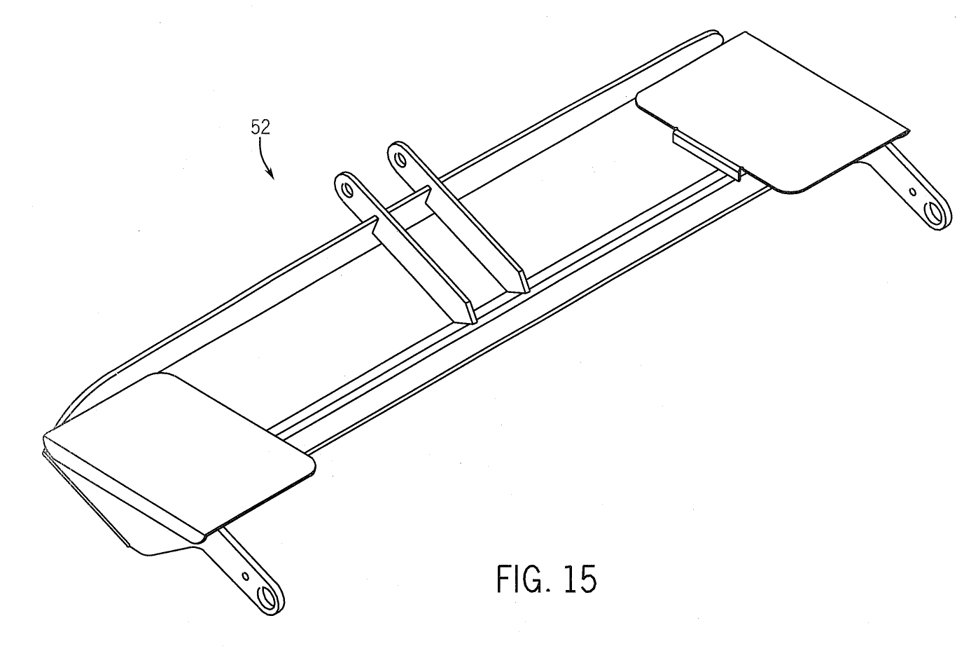

As is best shown in FIG. 7, the rear roller assembly 40 includes a frame 41 and a cylindrical roller 42. As is best shown in FIG. 8, the front assembly 50 comprises a roller frame 51 and cylindrical roller 53 and a spiker frame 52 (also shown in FIG. 15) and substantially cylindrical spiker 54. Significantly, the rear roller 42 rotates about an elongated spindle or axel 43 that has an axis that is normally substantially perpendicular to the front to rear axis “A” (shown in FIGS. 1 and 6) of the roller 10. The front roller 53 and spiker 54 also rotate around elongated axels 55 and 56 respectively, that are also normally substantially perpendicular to the front rear axis of the roller 10. This dictates that the roller 10 will always move substantially frontwardly 11 or rearwardly 12 and not side to side (13 or 14). This orientation and movement are in line with the operator sitting forwardly on the seat 25.

The roller 10 of the present invention provides better visibility to the operator, better control and is easier to operate than prior rollers.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A roller comprising a base having front, rear and opposing sides, an operator seat connected to the base and oriented toward the front of the roller, and at least one driven roller which normally rolls substantially in the front and rear directions.

2. The roller of claim 1, wherein the base comprises a frame.

3. The roller of claim 2, wherein a seat platform is connected to the frame and the seat is connected to the seat platform.

4. The roller of claim 1 wherein the frame has a foot deck disposed in front of the seat.

5. The roller of claim 1, wherein the seat is fixedly oriented toward the front of the roller.

6. The roller of claim 1 wherein the seat has a substantially horizontal base member and a substantially vertical back member.

7. The roller of claim 1 wherein the at least one driven roller is cylindrical and rotates about an elongated axis.

8. The roller of claim 7 wherein the elongated axis is oriented substantially normally side to side with respect to the roller.

9. The roller of claim 1 where in the at least one driven roller is steerable and pivotable with respect to the front and rear ends of the roller.

10. The roller of claim 1, wherein there at a plurality of rollers.

11. The roller of claim 1, wherein the driven roller is disposed rearwardly on the roller.

12. The roller of claim 10 wherein a second roller is disposed forwardly with respect to the drive roller.

13. The roller of claim 11, wherein the second roller is fixed and cannot turn.

14. The roller of claim 11 further comprising a spiker roller.

15. The roller of claim 1, further comprising a power plant and drive train communicatively connected to the drive roller.

16. The roller of claim 15 further comprising an electrical control system connected to the power plant.

17. The roller of claim 1, further comprising a steering wheel disposed forwardly of the operator seat.

18. The roller of claim 1 further comprising a nose cone disposed at the front of the roller.

19. A golf course greens roller, comprising
a. a base having front, rear and opposing sides, the base having a frame and at least one deck disposed on the frame;
b. an operator seat disposed on at least one base deck and fixedly oriented toward the front of the roller;
c. operator controls disposed in front of the seat; and
d. at least one driven roller which normally rolls substantially in the front and rear directions.

20. A golf course greens roller, comprising
a. a base having front, rear and opposing sides, the base having a frame and at least one deck disposed on the frame;
b. an operator seat disposed on at least one base deck and fixedly oriented toward the front of the roller;
c. operator controls disposed in front of the seat; and
d. a driven roller which normally rolls substantially in the front and rear directions, the driven roller being cylindrical and rotating about an elongated axis, the elongated axis being oriented substantially normally side to side with respect to the roller the driven roller being disposed behind the seat.
